(19) United States
(12) Patent Application Publication
(10) Pub. No.: US 2025/0382984 A1
(43) Pub. Date: Dec. 18, 2025

(54) CLAMP CONFIGURED TO ATTACH TO TRACKED TUBING TENT FRAME POLES FOR KEDERED-STYLE TENTS

(71) Applicant: Benjamin Scearce, Lugoff, SC (US)

(72) Inventor: Benjamin Scearce, Lugoff, SC (US)

(21) Appl. No.: 19/235,240

(22) Filed: Jun. 11, 2025

Related U.S. Application Data
(60) Provisional application No. 63/659,482, filed on Jun. 13, 2024.

(51) Int. Cl. F16B 7/04; E04H 15/32

(52) U.S. Cl. CPC F16B 7/04; E04H 15/32

(57) ABSTRACT

A clamp is configured to attach to a tracked tubing tent frame pole, like those for kedered-style tents with a pole body and two tracked portions on a side of the pole body. The clamp includes a main body with an open end. The main body is sized and configured to fit around the pole body of the tracked tubing tent frame pole. An attachment portion is on the open end of the main body. At least one attachment ear is included with the attachment portion. Each of the at least one attachment ears is positioned on one side of the attachment portion. Each of the attachment ears is sized and configured to be inserted into one of the tracked portions of the tracked tubing tent frame pole for securing the clamp on the tracked tubing tent frame pole.

### CROSS-REFERENCE TO RELATED APPLICATIONS

This application claims benefit to U.S. Provisional Patent Application No. 63/659,482 filed on Jun. 13, 2024, entitled Clamp configured to attach to Olympic style Kedered tent frame, which is incorporated by reference in its entirety.

### FIELD OF THE DISCLOSURE

The present disclosure relates to tents and tent frames and accessories therefore, namely tracked tubing tent fame poles for kedered-style tents and accessories therefore. More specifically, the present disclosure related to a clamp configured to attach to tracked tubing tent frame poles for kedered-style tents.

### BACKGROUND

Generally speaking, a tent is a shelter consisting of sheets of fabric or other material draped over or attached to a frame of poles or a supporting rope. While smaller tents may be free-standing or attached to the ground, large tents are usually anchored using guy ropes tied to stakes or tent pegs. First used as portable homes by nomads, tents are now more often used for recreational camping and as temporary shelters. Tents range in size from big enough for one person to sleep in, up to huge circus tents capable of seating thousands of people.

For larger tents, like party tents, or the like, aluminum frame marquee style tents are used as may be used in the instant disclosure. Aluminum frame tents have no center poles or guy ropes. This kind of tent can be erected on almost any surface and adjacent to buildings or annexed tents. The aluminum frame tent is much more stable and can span a much wider area over pools, flower beds or trees. The aluminum frame marquee style tent may be the most commonly used style for most retail rentals and can be found being used as temporary structures for storage in retail and military applications. Aluminum frame marquee tents typically have interchangeable parts, which allow for a rental company to easily expand to larger sizes. Tents can be ordered in a variety of colors, but white is by far the most popular color. Skylights can also be built into the fabric, which allow a greater amount of light to enter and is useful if walls are being used. Walls can also be ordered with clear vinyl windows in them.

A kedered style tent, as may be used by the instant disclosure, is a medium-duty frame tent made from aluminum tubing. It utilizes slide in style fabric roof sheets with ends that slide into a channel on the tent tubing, like on the tent rafter, and create a tight seal. Prior to kedered style tends, earlier methods for joining panels laced adjacent sections with loops and grommets to mechanical fasteners, like plastic side release buckles or metal clips. This process was somewhat dangerous and not an easy task requiring more time on a ladder. This process also shortened the life of the fabric by dragging the tops over the frames. Since then, kedered has become a household name in the industry. Kedered style tents are now used for several applications that require fabric to be attached to a frame. It can be installed many times and without even getting on a ladder. It is not visible in most projects, but is engineered for tolerance and reliability and creates an installer-friendly design. Kedered style tents can be found in small 10-foot-wide marquee frames to the largest tent structures in the world. Kedered style tents are designed to make installation easier with tighter roof panels, as well as sidewall systems that are superior.

The instant disclosure recognizes the need to hang materials from the tracked tubing tent frame poles for such kedered-style tents. With large tent projects, like for weddings or other events, lighting, extension cords, wiring, fire safety signs, the like, or other decorations or accessories naturally need to be hung below the roof of the tent. Typically, installers of such kedered-style tents utilize zip ties, rope, tape, or the like to hang such lighting, extension cords, wiring, fire safety signs, the like, or other decorations or accessories from the underside of the roof via the aluminum tubing. This is very difficult, adds extra costs, and is one of the most time-consuming tasks for tent installation. In addition, these zip ties have to be cut off when removed, leading to additional time and difficulty in disassembling the tent, and additional waste that has to be discarded. As such, there is clearly a need to provide a more efficient means for attaching things to the tubing of a tent, like lighting, wiring, extension cords, fire safety signs, the like, or other decorations or accessories.

The instant disclosure may be designed to address at least certain aspects of the problems or needs discussed above by providing a clamp configured to attach to tracked tubing tent frame poles for kedered-style tents.

### SUMMARY

The present disclosure may solve the aforementioned limitations of the currently available kedered tents, tracked tubing tent frame poles, and means for attaching accessories to such tracked tubing tent frame poles, by providing the disclose clamp. The disclosed clamp may be configured to attach to a tracked tubing tent frame pole, like those for kedered-style tents. The tracked tubing tent frame pole may include a pole body and two tracked portions on a side of the pole body. In general, the clamp may include a main body with an open end. The main body may be sized and configured to fit around the pole body of the tracked tubing tent frame pole. An attachment portion may be on the open end of the main body. At least one attachment car may be included with the attachment portion. Each of the at least one attachment cars may be positioned on one side of the attachment portion. Each of the attachment cars may be sized and configured to be inserted into one of the tracked portions of the tracked tubing tent frame pole for securing the clamp on the tracked tubing tent frame pole with the main body of the clamp around the pole body of the tracked tubing tent frame pole.

One feature of the disclosed clamp may be that the main body and the open end are flexible whereby the open end is configured to spread wider with a force and is configured to bias back with no force. Wherein, when the open end of the main body of the clamp is pushed onto an opposite side of the pole body from the two tracked portions, the open end may be configured to spread open thereby allowing the pole body to be inserted into the main body of the clamp through the open end of the main body. Wherein, once the pole body is inserted into the main body of the clamp, the open end may be configured to bias back, whereby the at least one attachment ear may be configured to lock onto a bottom portion of the one of the two tracked portions of the tracked tubing tent frame pole.

In select embodiments of the disclosed clamp, each of the at least one attachment cars may include a protrusion. The protrusion may protrude inward from the one side of the attachment portion. The protrusion may include a rounded top portion with a convex top surface and a concave bottom surface. Wherein, when the open end of the main body of the clamp is pushed onto an opposite side of the pole body from the two tracked portions, the convex top surface of the protrusion of each of the at least one attachment cars may be configured for spreading the open end for allowing the pole body to be inserted into the main body of the clamp through the open end of the main body. The concave bottom surface of the protrusion of the attachment ear may be configured for locking onto a bottom portion of the one of the tracked portions of the tracked tubing tent frame pole when the pole body is positioned in the main body of the clamp.

In select embodiments of the disclosed clamp, the attachment portion may include two of the attachment cars with a first attachment ear and a second attachment car. The first attachment ear may be on a first side of the attachment portion. The second attachment ear may be on a second side of the attachment portion. Wherein, the first attachment ear may be sized and configured to be inserted into one of the two tracked portions of the tracked tubing tent frame pole and the second attachment ear may be sized and configured to be inserted into the other of the two tracked portions of the tracked tubing tent frame pole for securing the clamp on the tracked tubing tent frame pole. In select embodiments, the main body and the open end may be flexible whereby the open end may be configured to spread wider with force and may be configured to bias back. Wherein, when the open end of the main body of the clamp may be pushed onto an opposite side of the pole body from the two tracked portions, the open end may be configured to spread open thereby allowing the pole body to be inserted into the main body of the clamp through the open end of the main body between the first attachment ear and the second attachment car. Wherein, once the pole body is inserted into the main body of the clamp, the open end may be configured to bias back, whereby the first attachment ear may be configured to lock onto a first bottom portion of the one of the two tracked portions of the tracked tubing tent frame pole and the second attachment ear may be configured to concurrently lock onto a second bottom portion of the other of the two tracked portions of the tracked tubing tent frame pole.

In select embodiments of the disclosed clamp, the first attachment ear may include a first protrusion protruding inward from the first side of the attachment portion. The first protrusion may include a first convex top surface and a first concave bottom surface. Likewise, the second attachment ear may include a second protrusion protruding inward from the second side of the attachment portion. The second protrusion may include a second convex top surface and a second concave bottom surface. Wherein, when the open end of the main body of the clamp is pushed onto an opposite side of the pole body from the two tracked portions, the first convex top surface of the first protrusion of the first attachment ear and/or the second convex top surface of the second protrusion of the second attachment ear may be configured for spreading the open end for allowing the pole body to be inserted into the main body of the clamp through the open end of the main body. And when the pole body is positioned in the main body of the clamp: the first concave bottom surface of the first protrusion of the first attachment ear may be configured for locking onto a first bottom portion of the first of the two tracked portions of the tracked tubing tent frame pole; and the second concave bottom surface of the second protrusion of the second attachment ear may be configured for concurrently locking onto a second bottom portion of the second of the two tracked portions of the tracked tubing tent frame pole.

Another feature of the disclosed clamp may that in select embodiments at least one thumbnail tab may be included. The included thumbnail tab may be on an exterior of the main body. The at least one thumbnail tab may be configured for opening the clamp thereby removing each of the at least one attachment cars from the tracked portions of the tracked tubing tent frame pole for removing the clamp from the tracked tubing tent frame pole. In select embodiments of the clamp, two thumbnail tabs may be included. A first thumbnail tab may be on a first exterior side of the main body. A second thumbnail tab may be on a second exterior side of the main body. Wherein, the clamp may be configured to be removed from the tracked tubing tent frame pole via pulling apart the two thumbnail tabs.

Another feature of the disclosed clamp may be that it can be configured for securing accessories to the tracked tubing tent frame pole. The accessories that are securable to the tracked tubing tent frame pole via the clamp may include any accessories or decorations, including, but clearly not limited thereto, lighting accessories, extension cords, wiring, fire safety signs, the like, and/or combinations thereof. In select embodiments of the clamp, the main body of the clamp may include an accessories connector configured for securing the accessories to the tracked tubing tent frame pole. Wherein the accessories connector may include, but is clearly not limited thereto, at least one accessories hole through the main body, at least one accessories slot through the main body, at least one accessories passage through the main body, at least one accessories hook on the main body, the like, and/or combinations thereof. In select embodiments, the accessories connector may include: a thumbnail accessories passage through at least one thumbnail tab on an exterior of the main body; a bottom accessories slot formed on the exterior of the main body between the main body and a flat portion connected to the main body; accessory holes on the flat portion; a bottom accessories passage through at least one rounded addition on an exterior of the main body; the like; and/or combinations thereof.

In select embodiments of the disclosed clamp, the main body may be configured to fit around a tracked tubing tent frame pole with a standard tubular cross-section. In these embodiments, the clamp may include an essentially rounded inner portion of the main body configured to fit around the standard tubular cross-section. In select embodiments where the main body includes an essentially rounded inner portion, the clamp may further include: two of the attachment cars; two thumbnail tabs; a thumbnail accessories passage through each of the two thumbnail tabs on the exterior of the main body; an accessories slot formed on the exterior of the main body between the main body and a flat portion connected to the main body; and/or accessory holes on the flat portion.

In select embodiments of the disclosed clamp, the main body may be configured to fit around a tracked tubing tent frame pole with a rectangular reinforced tubular cross-section. In select of these embodiments, the clamp may include an extended inner portion of the main body configured to fit around the rectangular reinforced tubular cross-section. The extended inner portion may include a top rounded inner portion and an elongated straight portion. In select embodiments, the clamp may further include two of the attachment cars; two thumbnail tabs; a thumbnail accessories passage through each of the two thumbnail tabs on the exterior of the main body; bottom accessories passage on each side of the main body through rounded additions on each side of an exterior of the main body; and/or accessory holes on a flat bottom portion of the main body.

In other select embodiments of the clamp with the main body configured to fit around a tracked tubing tent frame pole with a rectangular reinforced tubular cross-section, the clamp may include an elongated purely rectangular portion of the main body configured to fit around the rectangular reinforced tubular cross-section. In these embodiments, the clamp may further include a rounded protrusion on the bottom of the elongated purely rectangular portion of the main body. The rounded protrusion may be configured to be positioned in a bottom slot of the rectangular reinforced tubular cross-section.

In another aspect, the instant disclosure embraces the disclosed clamp configured to attach to a tracked tubing tent frame pole for kedered-style tents in any of the embodiments and/or combinations of embodiments shown and/or described herein.

In another aspect, the instant disclosure embraces the disclosed clamp configured to attach to a tracked tubing tent frame pole for kedered-style tents with a standard tubular cross-section in any of the embodiments and/or combinations of embodiments shown and/or described herein. In these embodiments of the clamp for the tracked tubing tent frame pole with a pole body with a standard tubular cross-section and two tracked portions on a side of the pole body, the clamp may generally include a main body with an open end. The main body may be sized and configured to fit around the pole body of the tracked tubing tent frame pole with an essentially rounded inner portion. The attachment portion may be on the open end of the main body. At least one attachment ear may be included with the attachment portion. Each of the at least one attachment ears may be positioned on one side of the attachment portion. Each of the attachment cars may be sized and configured to be inserted into one of the tracked portions of the tracked tubing tent frame pole for securing the clamp on the tracked tubing tent frame pole with the main body of the clamp around the pole body of the tracked tubing tent frame pole. Wherein, the main body may be configured to fit around the tracked tubing tent frame pole with the standard tubular cross-section.

In another aspect, the instant disclosure embraces the disclosed clamp configured to attach to a tracked tubing tent frame pole for kedered-style tents with a rectangular reinforced tubular cross-section in any of the embodiments and/or combinations of embodiments shown and/or described herein. In these embodiments of the clamp for the tracked tubing tent frame pole with a pole body with a rectangular reinforced tubular cross-section and two tracked portions on a side of the pole body, the clamp may generally include a main body with an open end. The main body may be sized and configured to fit around the pole body of the tracked tubing tent frame pole. An attachment portion may be included on the open end of the main body. At least one attachment ear may be included with the attachment portion. Each of the at least one attachment ears may be positioned on one side of the attachment portion. Each of the attachment cars may be sized and configured to be inserted into one of the tracked portions of the tracked tubing tent frame pole for securing the clamp on the tracked tubing tent frame pole with the main body of the clamp around the pole body of the tracked tubing tent frame pole. Wherein, the main body may be configured to fit around the tracked tubing tent frame pole with the rectangular reinforced tubular cross-section.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present apparatuses, systems and methods will be better understood by reading the disclosure with reference to the accompanying drawings, which are not necessarily drawn to scale, and in which like reference numerals denote similar structure and refer to like elements throughout, and in which:

FIG. 1 is a perspective view of a tracked tubing tent frame pole for kedered-style tents according to the prior art with a standard tubular cross-section;

FIG. 2 is a perspective view of a tracked tubing tent frame pole for kedered-style tents according to the prior art with a rectangular reinforced tubular cross-section;

FIG. 3 is a top, front (or back) left-side perspective view of the disclosed clamp configured to attach to a tracked tubing tent frame pole for kedered-style tents according to select embodiments of the instant disclosure;

FIG. 4 is a top, front (or back) right-side perspective view of the clamp from FIG. 3;

FIG. 5 is a bottom, front (or back) right-side perspective view of the clamp from FIG. 3;

FIG. 6 is a top view of the clamp from FIG. 3;

FIG. 7 is a front or back view of the clamp from FIG. 3;

FIG. 8 is a bottom view of the clamp from FIG. 3;

FIG. 9 is a left or right-side view of the clamp from FIG. 3;

FIG. 10A is an environmental perspective view of the clamp from FIG. 3 being inserted onto a tracked tubing tent frame pole for kedered-style tents with a standard tubular cross-section according to select embodiments of the instant disclosure;

FIG. 10B is an environmental perspective view of the clamp from FIG. 3 attached onto a tracked tubing tent frame pole for kedered-style tents with a standard tubular cross-section according to select embodiments of the instant disclosure;

FIG. 10C is an environmental perspective view of the clamp from FIG. 3 beginning to be removed from a tracked tubing tent frame pole for kedered-style tents with a standard tubular cross-section according to select embodiments of the instant disclosure showing the user pulling apart the thumbnail tabs with their fingers while pressing on the bottom of the clamp with their thumbs;

FIG. 10D is an environmental perspective view of the clamp from FIG. 3 being removed from a tracked tubing tent frame pole for kedered-style tents with a standard tubular cross-section according to select embodiments of the instant disclosure showing the user removing the clamp after pulling apart the thumbnail tabs with their fingers while pressing on the bottom of the clamp with their thumbs;

FIG. 11 is a left or right-side view of the clamp from FIG. 3 shown attached onto the tracked tubing tent frame pole for kedered-style tents according to the prior art with a standard tubular cross-section from FIG. 1;

FIG. 12 is a top, front (or back) left-side perspective view of the disclosed clamp configured to attach to a tracked tubing tent frame pole for kedered-style tents according to select embodiments of the instant disclosure;

FIG. 13 is a top, front (or back) right-side perspective view of the clamp from FIG. 12;

FIG. 14 is a bottom, front (or back) left-side perspective view of the clamp from FIG. 12;

FIG. 15 is a top view of the clamp from FIG. 12;

FIG. 16 is a front or back view of the clamp from FIG. 12;

FIG. 17 is a bottom view of the clamp from FIG. 12;

FIG. 18 is a left or right-side view of the clamp from FIG. 12;

FIG. 19 is a left or right-side view of the clamp from FIG. 12 shown attached onto the tracked tubing tent frame pole for kedered-style tents according to the prior art with a rectangular reinforced tubular cross-section from FIG. 2;

FIG. 20 is a top, front (or back) left-side perspective view of the disclosed clamp configured to attach to a tracked tubing tent frame pole for kedered-style tents according to select embodiments of the instant disclosure;

FIG. 21 is a top, front (or back) right-side perspective view of the clamp from FIG. 20;

FIG. 22 is a bottom, front (or back) left-side perspective view of the clamp from FIG. 20;

FIG. 23 is a top view of the clamp from FIG. 20;

FIG. 24 is a front or back view of the clamp from FIG. 20;

FIG. 25 is a bottom view of the clamp from FIG. 20;

FIG. 26 is a left or right-side view of the clamp from FIG. 20; and

FIG. 27 is a left or right-side view of the clamp from FIG. 20 shown attached onto the tracked tubing tent frame pole for kedered-style tents according to the prior art with a rectangular reinforced tubular cross-section from FIG. 2.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

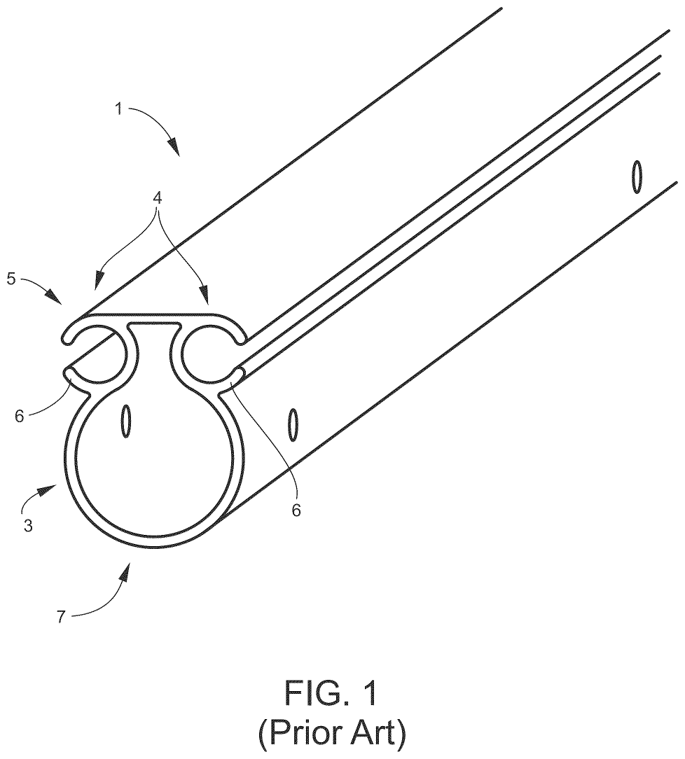

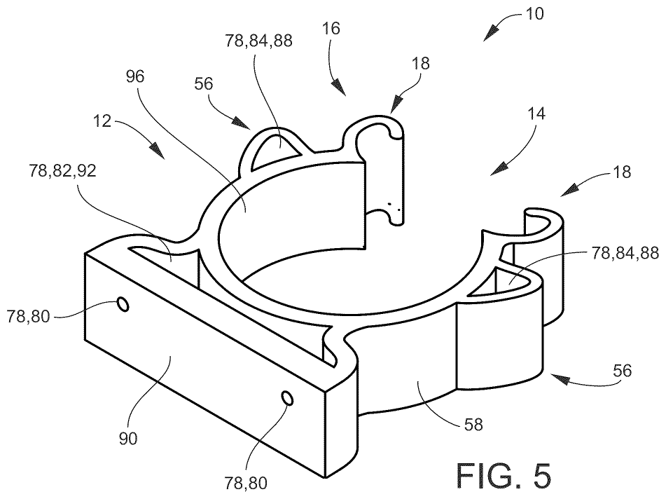

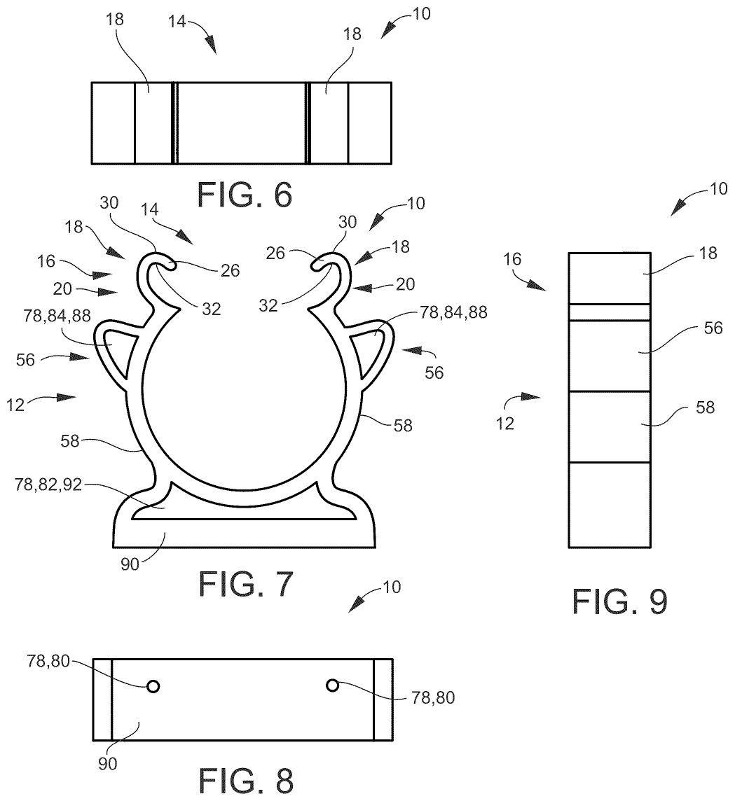

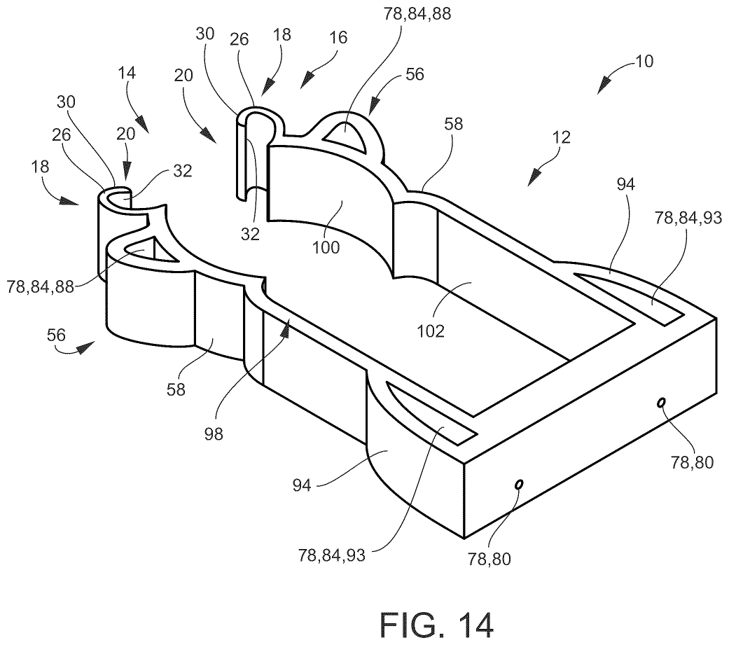

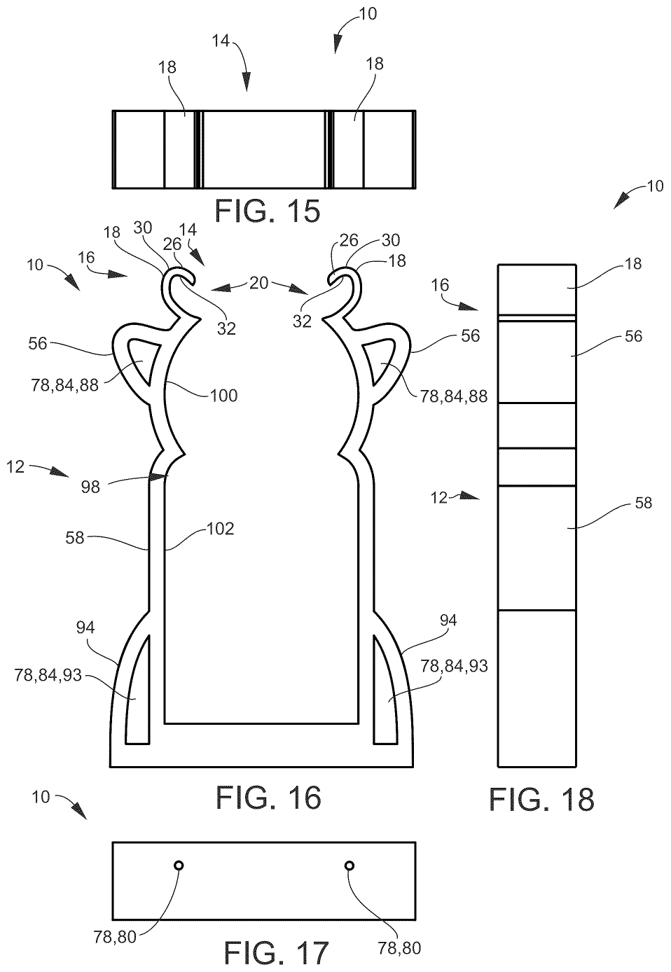

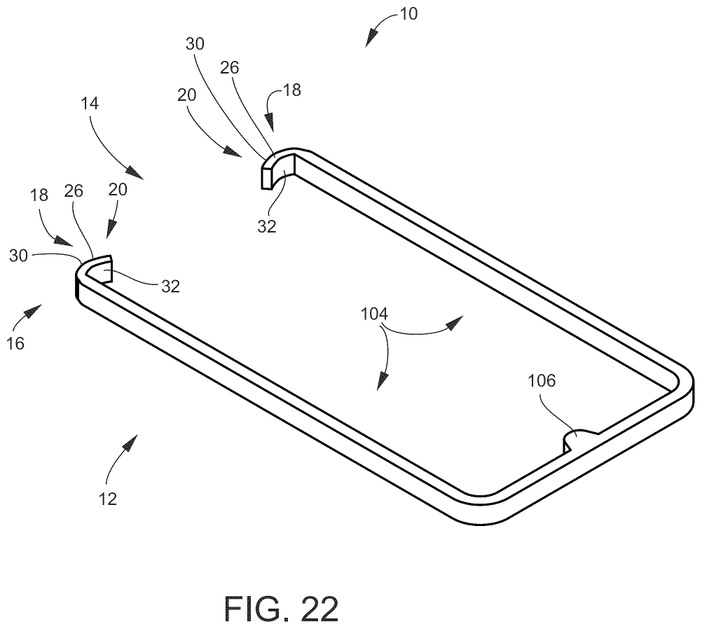

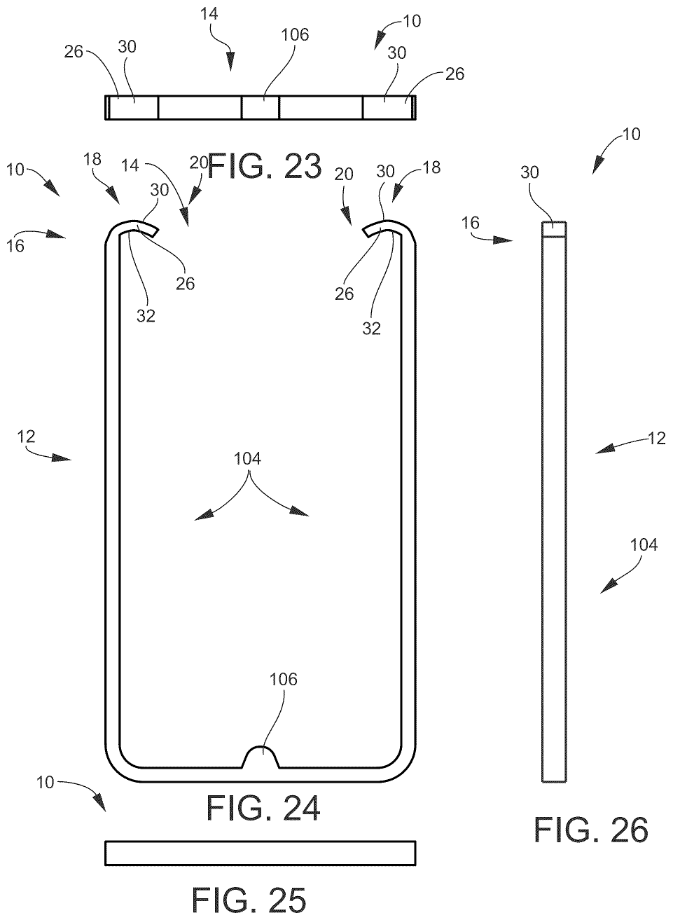

Referring now to FIGS. 1-27, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

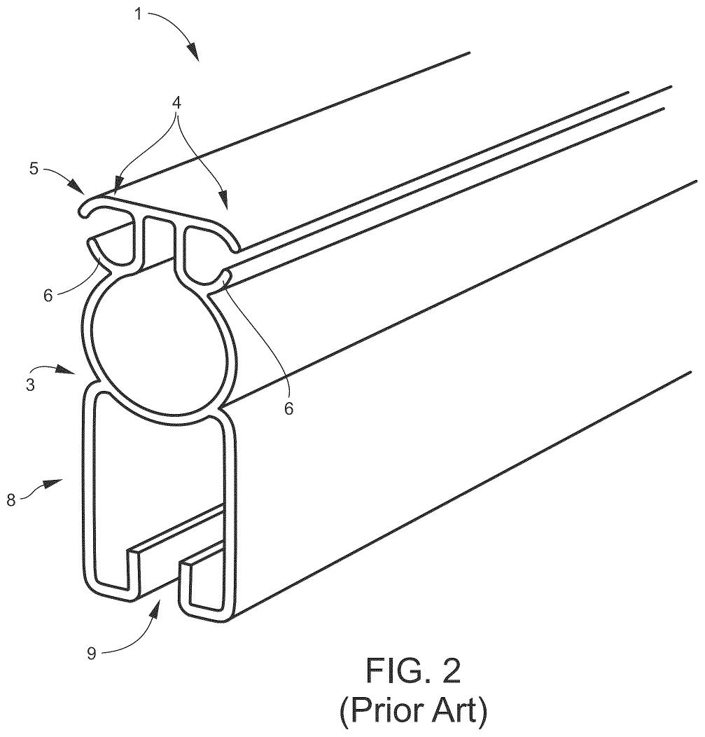

As shown in FIGS. 1-2, a couple of various standard tracked tubing tent fame poles 1 are shown according to the prior art that may be used with the instant disclosure. However, the disclosure is not so limited, and may be designed and/or configured for use on any various style, design and/or configuration of tracked tubing tent frame poles, like any tracked tubing tent frame poles configured for slide in fabrics, like kedered style slide in fabrics or coverings.

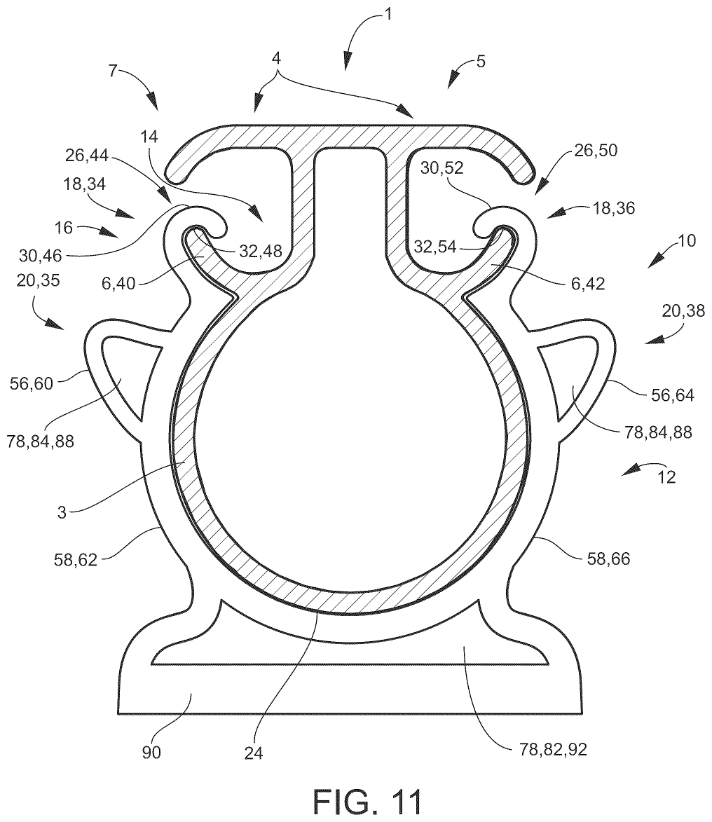

Referring specifically to FIG. 1, tracked tubing tent frame pole 1 with standard tubular cross-section 7 is shown according to the prior art. As shown in FIG. 1 (also shown in FIG. 11), tracked tubing tent frame pole 1 with standard tubular cross-section 7 includes pole body 3 with such standard tubular cross-section 7. Two tracked portions 4 are included on side 5 of pole body 3. Tracked portions 4 are configured for connecting kedered style fabric roof sheets or sides with ends that are sized and configured to slide into tracked portions 4 on such tracked tubing tent frame pole 1 with standard tubular cross-section 7, like when used on the tent rafter, the like, etc., to create a tight seal for the tent. As shown, each tracked portion 4 includes a slot for the fabric with bottom portion 6 of the track under the slot. An example of such a tracked tubing tent frame pole 1 with standard tubular cross-section 7 may be provided by Olympic Tent of Tacoma, Washington, under the name MAXI LITE TRACK TENT TUBING, which is described as a robust 2-inch tube system offering the benefits of slide-in fabric tops (kedered fabric tops) for various widths, providing a cost effective solution for smaller tents.

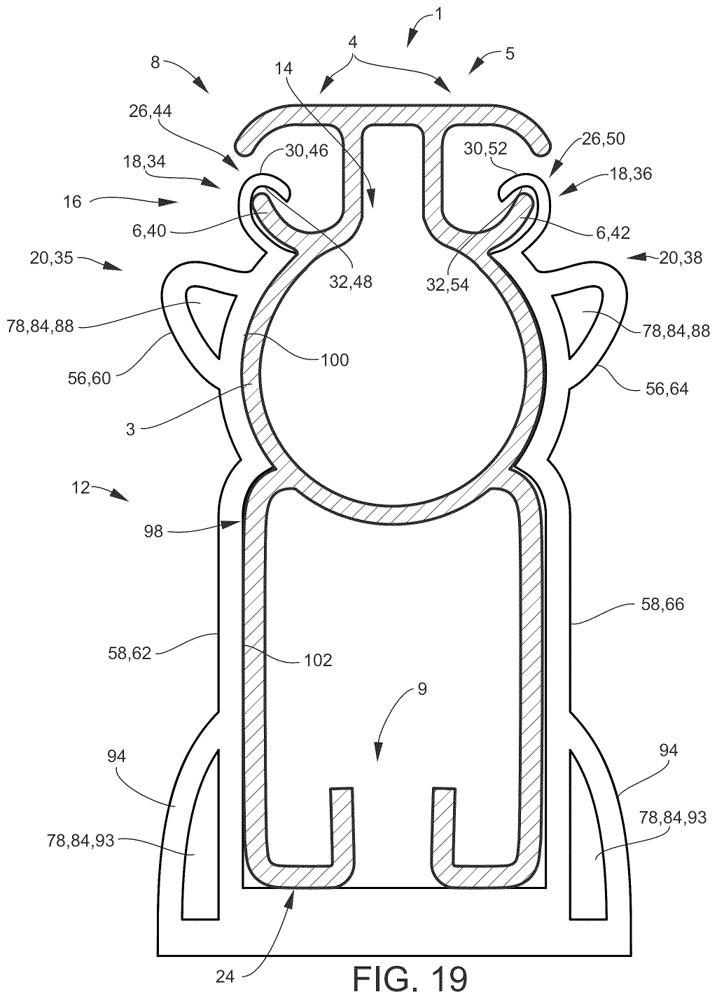

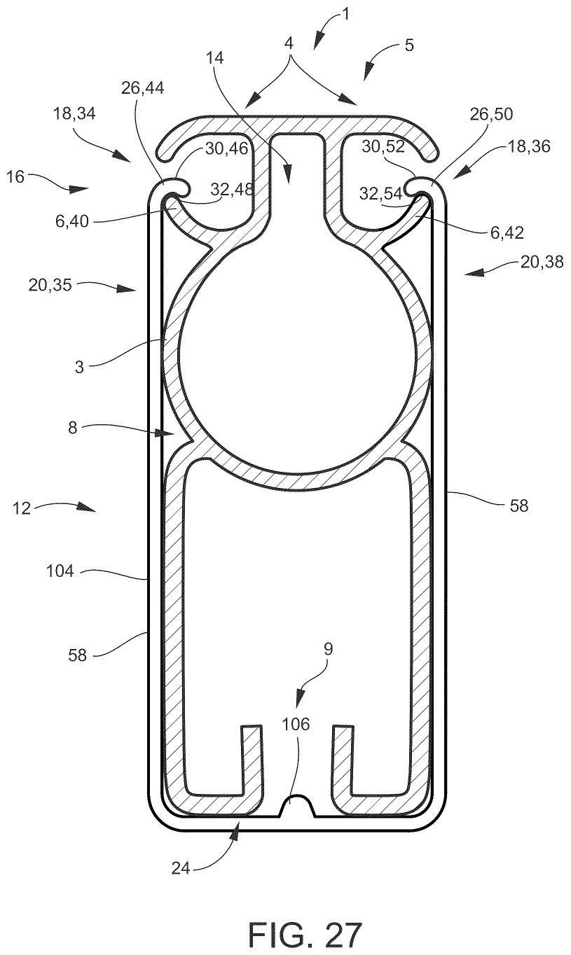

Referring now to FIG. 2, tracked tubing tent frame pole 1 with rectangular reinforced tubular cross-section 8 is shown according to the prior art. As shown in FIG. 2 (also shown in FIGS. 19 and 27), tracked tubing tent frame pole 1 with rectangular reinforced tubular cross-section 8 includes pole body 3 with such rectangular reinforced tubular cross-section 8. Two tracked portions 4 are included on side 5 of pole body 3. Similar to the embodiment shown in FIG. 1, tracked portions 4 are configured for connecting kedered style fabric roof sheets or sides with ends that are sized and configured to slide into tracked portions 4 on such tracked tubing tent frame pole 1 with rectangular reinforced tubular cross-section 8, like when used on the tent rafter, the like, etc., to create a tight seal for the tent. As shown, each tracked portion 4 includes a slot for the fabric with bottom portion 6 of the track under the slot. With this rectangular reinforced tubular cross-section 8 of tracked tubing tent frame pole 1, bottom slot 9 may be included on the bottom of rectangular reinforced tubular cross-section 8. An example of such a tracked tubing tent frame pole 1 with rectangular reinforced tubular cross-section 8 may be provided by Olympic Tent of Tacoma, Washington, under the name MAXI TUBE II TENT TUBING, which is described as featuring kedered tracks for quick, easy tent top installation and enhanced stability, suitable for retrofitting round tube frame systems.

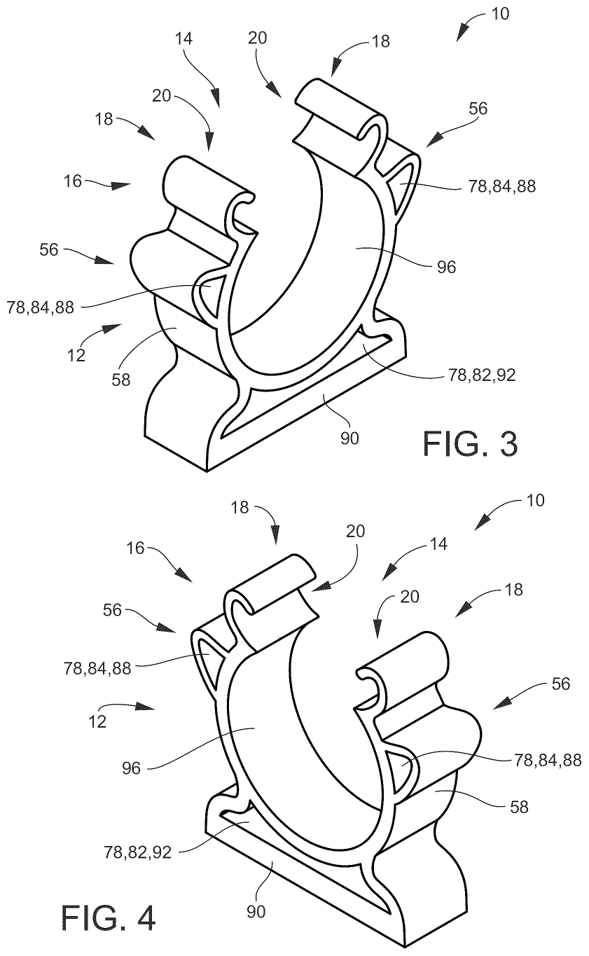

Referring now to FIGS. 3-27, The present disclosure may solve the aforementioned limitations of the currently available kedered tents, tracked tubing tent frame poles, and means for attaching accessories to such tracked tubing tent frame poles, by providing clamp 10. Clamp 10 may be configured to attach to tracked tubing tent frame pole 1, like those for kedered-style tents (as non-limiting examples, see FIGS. 1 and 2). In general, clamp 10 may include main body 12 with open end 14. Open end 14 may be sized and configured to allow for clamp to be inserted around tracked tubing tent frame pole 1. Main body 12 may be sized and configured to fit around pole body 3 of tracked tubing tent frame pole 1, including but not limited to standard tubular cross-section 7, as shown in FIGS. 1 and 11, and rectangular reinforced tubular cross section 8, as shown in FIGS. 2, 19, and 27. As an example, and clearly not limited thereto, in select embodiments, main body may include a 50 mm internal measurement. Attachment portion 16 may be included on open end 14 of main body 12. Attachment portion 16 may be designed and configured for attaching clamp 10 onto tracks portions 4, like on bottom portion 6 of tracked portions 4. Attachment portion 16 may include any device or configuration for attaching clamp 10 onto tracked portions 4. In select embodiments, as shown in the Figures, at least one attachment ear 18 may be included with attachment portion 16. Each of the at least one attachment cars 18 may be positioned on one side of attachment portion 16. Each of the attachment cars 18 may be sized and configured to be inserted into one of tracked portions 4 of tracked tubing tent frame pole 1 for securing clamp 10 on tracked tubing tent frame pole 1 with main body 12 of clamp 10 positioned around pole body 3 of tracked tubing tent frame pole 1.

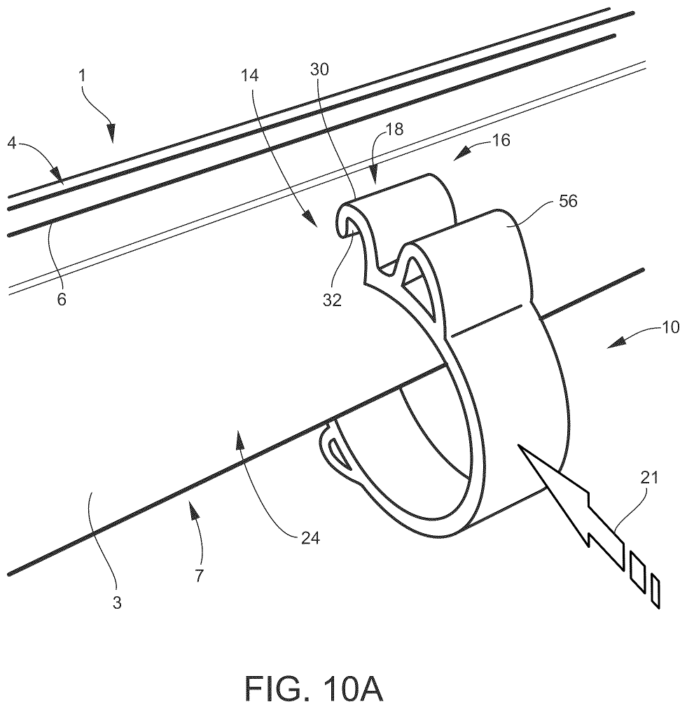

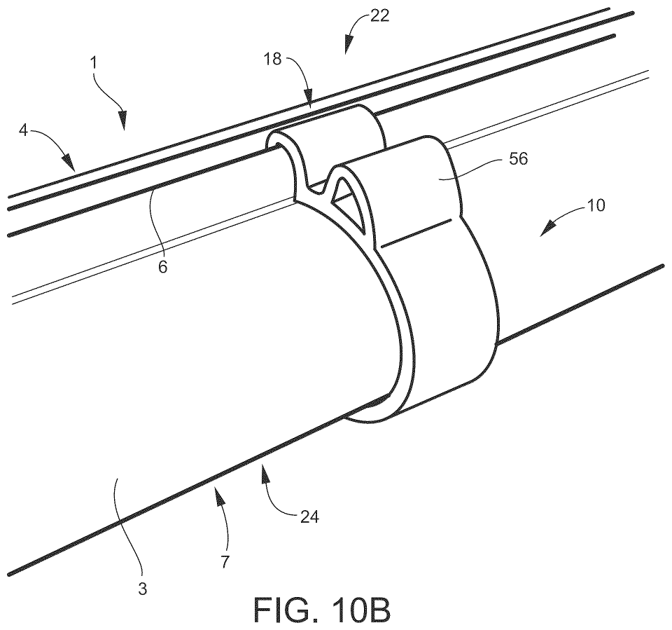

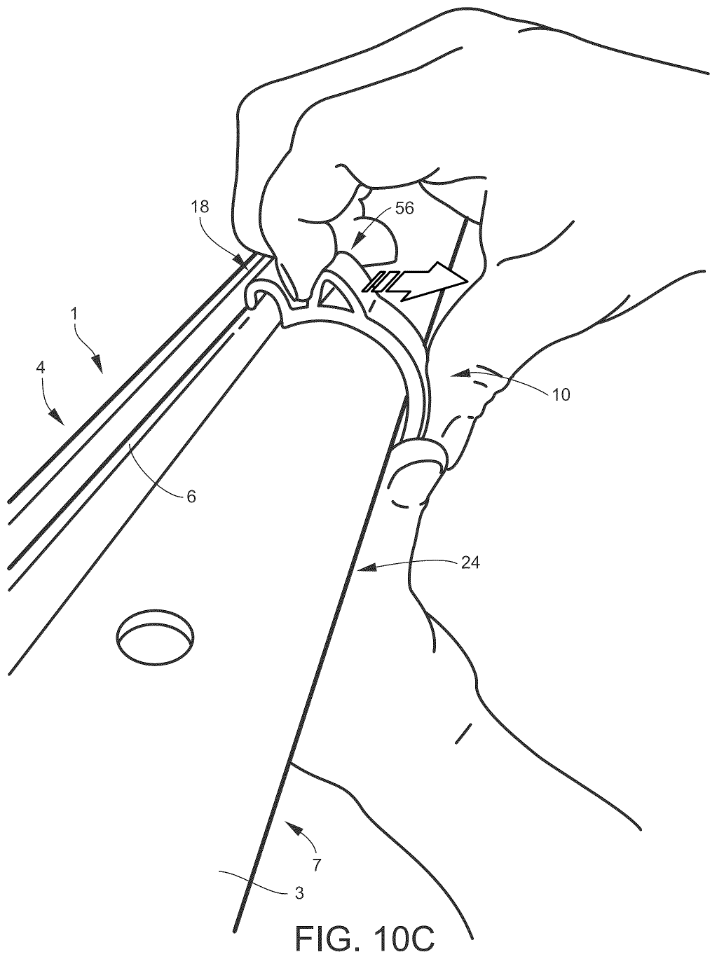

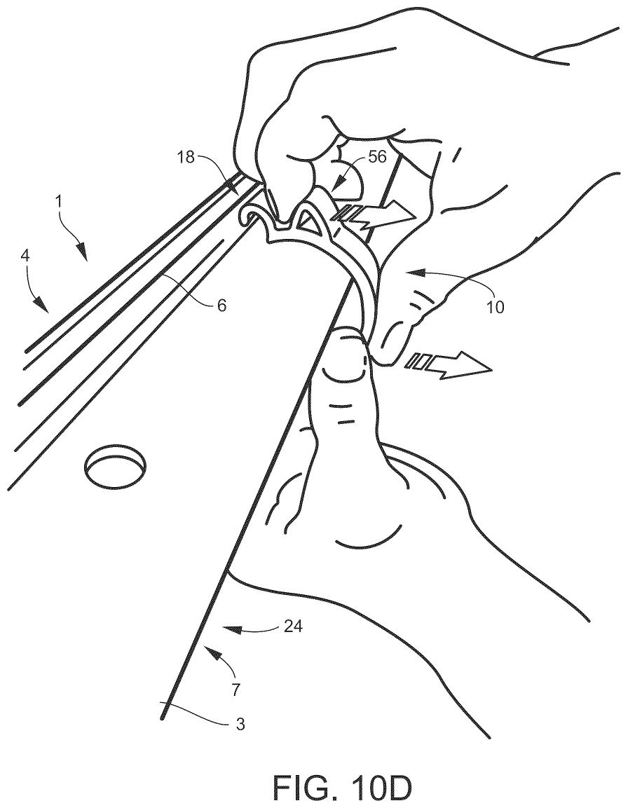

One feature of clamp 10 may be that main body 12 and open end 14 may be flexible. As such, clamp 10 may be made from a flexible material, including, but not limited to, various hard plastics, hard rubbers, thin metals, the like, etc. With clamp 10 being flexible, open end 14 may be configured to spread wider with force 21 (see FIG. 10A) and may be configured to bias back with no force 21 applied. Wherein, when open end 14 of main body 12 of clamp 10 is pushed onto opposite side 24 of pole body 3 from two tracked portions 4, open end 14 may be configured to spread open thereby allowing pole body 3 to be inserted into main body 12 of clamp 10 through open end 14 of main body 12 (see FIGS. 10A-10B). Wherein, once pole body 3 is inserted into main body 12 of clamp 10, open end 14 may be configured to bias back, whereby the at least one attachment ear 18 may be configured to lock onto bottom portion 6 of the one of the two tracked portions 4 of tracked tubing tent frame pole 1 (see FIGS. 10B, 11, 19 and 27).

Attachment ear or cars 18 of clamp 10 may be designed and configured with any shape, style or mechanism for attaching to tracked portions 4 of tracked tubing tent frame pole 1. In select embodiments of clamp 10, as shown in the Figures and clearly not limited thereto, each of the at least one attachment ears 18 may include protrusion 26. Protrusion 26 of each attachment ear 18 may protrude inward from one side 20 of attachment portion 16. Each protrusion 26 may be designed and/or configured with various shapes and sizes for locking onto tracked portion 4. As an example, and clearly not limited thereto, in select embodiments protrusions 26 of attachment cars 18 may be 3 mm cars on top of clamp 10 configured to clip into the tracked portion 4 of tracked tubing tent frame pole 1. In select embodiments, each protrusion 26 may include rounded top portion 28 with convex top surface 30 and concave bottom surface 32. In other words, each protrusion 26 may be designed as a hook style protrusion, or an car shaped style protrusion. Wherein, when open end 14 of main body 12 of clamp 10 is pushed onto opposite side 24 of pole body 3 from two tracked portions 4 (see FIG. 10A), convex top surface 30 of protrusion 26 of each of the at least one attachment cars 18 may be configured for spreading open end 14 for allowing pole body 3 to be inserted into main body 12 of clamp 10 through open end 14 of main body 12. Concave bottom surface 32 of protrusion 26 of each attachment ear 18 may be configured for locking onto bottom portion 6 of the one of tracked portions 4 of tracked tubing tent frame pole 1 when pole body 3 is positioned in main body 12 of clamp 10 (best shown in FIGS. 11, 19 and 27).

As shown in the Figures, in select possibly preferred embodiments of clamp 10, attachment portion 16 may include two of the attachment cars 18 with first attachment ear 34 and second attachment ear 36. First attachment ear 34 may be on first side 35 of attachment portion 16. Second attachment ear 36 may be on second side 38 of attachment portion 16. Wherein, first attachment ear 34 may be sized and configured to be inserted into one of the two tracked portions 4 of tracked tubing tent frame pole 1 and second attachment ear 36 may be sized and configured to be inserted into the other of the two tracked portions 4 of tracked tubing tent frame pole 1 for securing clamp 10 on tracked tubing tent frame pole 1. In select embodiments, main body 12 and open end 14 may be flexible whereby open end 14 may be configured to spread wider with force 21 and may be configured to bias back. Wherein, when open end 14 of main body 12 of clamp 10 may be pushed onto opposite side 24 of pole body 3 from two tracked portions 4 (see FIG. 10A), open end 14 may be configured to spread open thereby allowing pole body 3 to be inserted into main body 12 of clamp 10 through open end 14 of main body 12 between first attachment ear 34 and second attachment ear 36. Wherein, once pole body 3 is inserted into main body 12 of clamp 10, open end 14 may be configured to bias back, whereby first attachment ear 34 may be configured to lock onto first bottom portion 40 of one of the two tracked portions 4 of tracked tubing tent frame pole 1 and second attachment ear 36 may be configured to concurrently lock onto second bottom portion 42 of the other of the two tracked portions 4 of tracked tubing tent frame pole 1 (see FIGS. 11, 19 and 27).

As shown in the Figures, in select possibly preferred embodiments of clamp 10, first attachment ear 34 may include first protrusion 44 protruding inward from first side 35 of attachment portion 16. First protrusion 44 may include first convex top surface 46 and first concave bottom surface 48. Likewise, second attachment ear 36 may include second protrusion 50 protruding inward from second side 38 of attachment portion 16. Second protrusion 50 may include second convex top surface 52 convex top surface and second concave bottom surface 54. Wherein, when open end 14 of main body 12 of clamp 10 is pushed onto opposite side 24 of pole body 3 from two tracked portions 4 (see FIG. 10A), first convex top surface 46 of first protrusion 44 of first attachment ear 34 and/or second convex top surface 52 of second protrusion 50 of second attachment ear 36 may be configured for spreading open end 14 for allowing pole body 3 to be inserted into main body 12 of clamp 10 through open end 14 of main body 12 (see FIG. 10A). And when pole body 3 is positioned in main body 12 of clamp 10: first concave bottom surface 48 of first protrusion 44 of first attachment ear 34 may be configured for locking onto first bottom portion 40 of first of the two tracked portions 4 of tracked tubing tent frame pole 1; and second concave bottom surface 54 of second protrusion 50 of second attachment ear 36 may be configured for concurrently locking onto second bottom portion 42 of second of the two tracked portions 4 of tracked tubing tent frame pole 1 (see FIGS. 11, 19 and 27).

Once clamp 10 is locked onto tracked tent frame pole 1, clamp 10 may be removed by any means or tools. In select embodiments, as shown in FIGS. 3-19, another feature of clamp 10 may that at least one thumbnail tab 56 may be included. The included thumbnail tab 56 may be on exterior 58 of main body 12 of clamp 10. The at least one thumbnail tab 56 may be configured for aiding in opening clamp 10 thereby removing each of the at least one attachment cars 18 from tracked portions 4 of tracked tubing tent frame pole 1 for removing clamp 10 from tracked tubing tent frame pole 1 (see FIGS. 10C-10D). In select embodiments of clamp 10, as shown in FIGS. 3-19, two thumbnail tabs 56 may be included. First thumbnail tab 60 may be on first exterior side 62 of main body 12. Second thumbnail tab 64 may be on second exterior side 66 of main body 12. Wherein, clamp 10 may be configured to be removed from tracked tubing tent frame pole 1 via pulling apart one or both of two thumbnail tabs 56, including pulling apart first thumbnail tab 60 and/or second thumbnail tab 64. As shown in FIGS. 10C-10D, a user may utilize thumbnail tabs 56 by pulling apart the thumbnail tabs 56 with their fingers while pressing on the bottom of clamp 10 with their thumbs. This may provide ample force to spread apart open end 14 of main body 12 for removing protrusions 26 from tracked portions 4 and allowing clamp 10 to be slid off of pole body 3 of tracked tubing tent frame pole 1. Thumbnail tabs 56 may be sized and shaped with any surface aiding in allowing the user to pull open the open end 14 of clamp 10. As shown in the Figures, in select embodiments thumbnail tabs 56 may included rounded extensions off of exterior 58 of main body 12. These rounded protrusions may include a top surface that is flat or slightly inclined to aid in allowing the user to pull apart clamp 10.

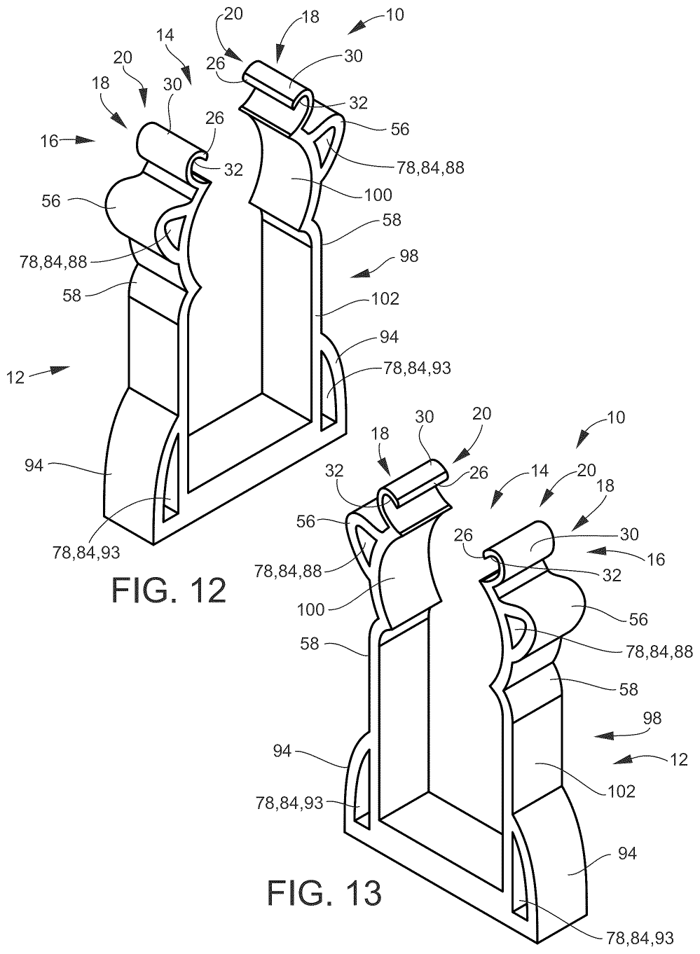

Another feature of clamp 10 may be that it can be configured for securing accessories to tracked tubing tent frame pole 1. Clamp 10 may be utilized for compressing various accessories or hangers for accessories between main body 12 of clamp 10 and pole body 3 of tracked tubing tent frame pole 1. The accessories that are securable to tracked tubing tent frame pole 1 via clamp 10 may be any desired accessories, decorations, or the like, that are desired and/or required to be attached to tracked tubing tent frame pole 1. As examples, and clearly not limited thereto, the accessories that are securable to tracked tubing tent frame pole 1 via clamp 10 may include, but are clearly not limited thereto, lighting accessories, extension cords, wiring, fire safety signs, the like, and/or combinations thereof. In select embodiments of clamp 10, main body 12 of clamp 10 may include at least one accessories connector 78 or a plurality of accessories connectors 78. Each accessories connector 78 may be configured for securing various accessories to tracked tubing tent frame pole 1 with clamp 10. In select embodiments, accessories connector 78 may include, but is clearly not limited thereto, at least one accessories hole 80 through main body 12, at least one accessories slot 82 through main body 12, at least one accessories passage 84 through main body 12, at least one accessories hook on main body 12, the like, and/or combinations thereof. In select embodiments, as shown in FIGS. 3-19, accessories connector 78 may include: thumbnail accessories passage 88 through at least one thumbnail tab 56 on exterior 58 of main body 12 (see FIGS. 3-19); bottom accessories slot 92 formed on exterior 58 of main body 12 between main body 12 and flat portion 90 connected to main body 12 (see FIGS. 3-11); accessory holes 80 on flat portion 90 (see FIGS. 3-19); bottom accessories passage 93 through at least one rounded addition 94 (see FIGS. 12-19) on exterior 58 of main body 12; the like; and/or combinations thereof.

Referring now specifically to FIGS. 3-11, in select embodiments of clamp 10, main body 12 may be configured to fit around tracked tubing tent frame pole 1 with standard tubular cross-section 7. In these embodiments, clamp 10 may include essentially rounded inner portion 96 of main body 12 configured to fit around standard tubular cross-section 7. In select embodiments, as shown in FIGS. 3-11, where main body 12 includes essentially rounded inner portion 96, clamp 10 may further include: two of the attachment cars 18 (first attachment ear 34 and second attachment ear 36); two thumbnail tabs 56 (first thumbnail tab 60 and second thumbnail tab 64); thumbnail accessories passage 88 through each of the two thumbnail tabs 56 on exterior 58 of main body 12; bottom accessories slot 92 formed on exterior 58 of main body 12 between main body 12 and flat portion 90 connected to main body 12; and/or accessory holes 80 on flat portion 90.

Referring now specifically to FIGS. 12-19, in select embodiments of clamp 10, main body 12 may be configured to fit around tracked tubing tent frame pole 1 with rectangular reinforced tubular cross-section 8. In select of these embodiments, clamp 10 may include extended inner portion 98 of main body 12 configured to fit around rectangular reinforced tubular cross-section 8. Extended inner portion 98 may include top rounded inner portion 100 and elongated straight portion 102. In select embodiments, clamp 10 may further include two of the attachment cars 18 (first attachment ear 34 and second attachment ear 36); two thumbnail tabs 56 (first thumbnail tab 60 and second thumbnail tab 64); thumbnail accessories passage 88 through each of the two thumbnail tabs 56 on exterior 58 of main body 12; bottom accessories passage 93 on each side (62 and 66) of main body 12 through rounded additions 94 on each side (62 and 66) of exterior 58 of main body 12; and/or accessory holes 80 on flat bottom portion 90 of main body 12.

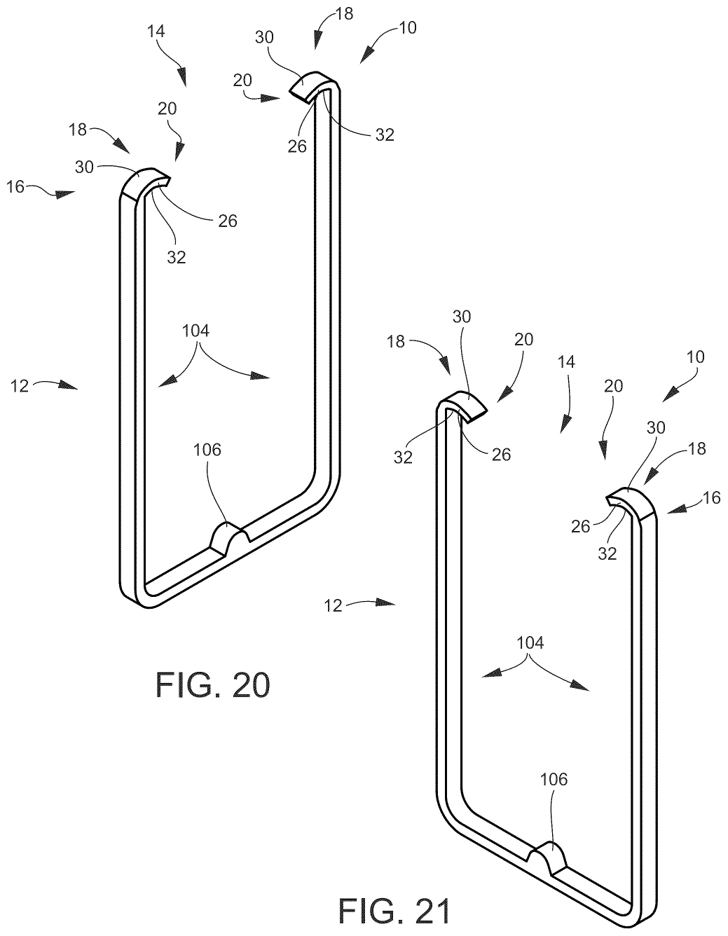

Referring now specifically to FIGS. 20-27, in other select embodiments of clamp 10 withe main body 12 configured to fit around tracked tubing tent frame pole 1 with rectangular reinforced tubular cross-section 8, clamp 10 may include elongated purely rectangular portion 104 of main body 12 configured to fit around rectangular reinforced tubular cross-section 8. In these embodiments, clamp 10 may further include rounded protrusion 106 on the bottom of the elongated purely rectangular portion 104 of main body 12. Rounded protrusion 106 may be configured to be positioned in bottom slot 9 of rectangular reinforced tubular cross-section 8.

In another aspect, the instant disclosure embraces clamp 10 configured to attach to tracked tubing tent frame pole 1 for kedered-style tents in any of the embodiments and/or combinations of embodiments shown and/or described herein.

In sum, clamp 10 may be configured to attach to tracked tubing tent frame poles 1, like once used in an Olympic style kedered tent frame provided by Olympic Tent of Tacoma, Washington, including, but not limited to, under the name MAXI LITE TRACK TENT TUBING and/or MAXI TUBE II TENT TUBING. As such, a feature of clamp 10 may be its ability to securely clamp into Olympic style kedered tent frame for large Track and Small track frame with the provided attachment ears 18. Another feature of clamp 10 may be its ability to quickly connect and disconnect using thumbnails tabs 56 on exterior 58 of main body 12 of clamp 10

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A clamp configured to attach to a tracked tubing tent frame pole for kedered-style tents, the tracked tubing tent frame pole including a pole body and two tracked portions on a side of the pole body, the clamp comprising:
a main body with an open end, the main body is sized and configured to fit around the pole body of the tracked tubing tent frame pole;
an attachment portion on the open end of the main body;
at least one attachment ear included with the attachment portion, each of the at least one attachment ear is positioned on one side of the attachment portion; and
each of the attachment ear is sized and configured to be inserted into one of the tracked portions of the tracked tubing tent frame pole for securing the clamp on the tracked tubing tent frame pole with the main body of the clamp around the pole body of the tracked tubing tent frame pole.

2. The clamp of claim 1, wherein:
the main body and the open end are flexible whereby the open end is configured to spread wider with a force and is configured to bias back, wherein, when the open end of the main body of the clamp is pushed onto an opposite side of the pole body from the two tracked portions, the open end is configured to spread open thereby allowing the pole body to be inserted into the main body of the clamp through the open end of the main body; and
once the pole body is inserted into the main body of the clamp, the open end is configured to bias back, whereby the at least one attachment ear is configured to lock onto a bottom portion of the one of the two tracked portions of the tracked tubing tent frame pole.

3. The clamp of claim 1, wherein each of the at least one attachment ear including:
a protrusion protruding inward from the one side of the attachment portion;
the protrusion including a rounded top portion with a convex top surface and a concave bottom surface;
wherein when the open end of the main body of the clamp is pushed onto an opposite side of the pole body from the two tracked portions, the convex top surface of the protrusion of each of the at least one attachment ear is configured for spreading the open end for allowing the pole body to be inserted into the main body of the clamp through the open end of the main body; and
wherein the concave bottom surface of the protrusion of the attachment ear is configured for locking onto a bottom portion of the one of the tracked portions of the tracked tubing tent frame pole when the pole body is positioned in the main body of the clamp.

4. The clamp of claim 1, wherein the attachment portion including two of the at least one attachment ear including:
a first attachment ear on a first side of the attachment portion;
a second attachment ear on a second side of the attachment portion; and
wherein, the first attachment ear is sized and configured to be inserted into one of the two tracked portions of the tracked tubing tent frame pole and the second attachment ear is sized and configured to be inserted into the other of the two tracked portions of the tracked tubing tent frame pole for securing the clamp on the tracked tubing tent frame pole.

5. The clamp of claim 4, wherein the main body and the open end are flexible whereby the open end is configured to spread wider with force and is configured to bias back, wherein, when the open end of the main body of the clamp is pushed onto an opposite side of the pole body from the two tracked portions, the open end is configured to spread open thereby allowing the pole body to be inserted into the main body of the clamp through the open end of the main body between the first attachment ear and the second attachment ear; and
wherein, once the pole body is inserted into the main body of the clamp, the open end is configured to bias back, whereby the first attachment ear is configured to lock onto a first bottom portion of the one of the two tracked portions of the tracked tubing tent frame pole and the second attachment ear is configured to concurrently lock onto a second bottom portion of the other of the two tracked portions of the tracked tubing tent frame pole.

6. The clamp of claim 5, wherein:
the first attachment ear including:
a first protrusion protruding inward from the first side of the attachment portion;
the first protrusion including a first convex top surface and a first concave bottom surface;
the second attachment ear including:
a second protrusion protruding inward from the second side of the attachment portion;
the second protrusion including a second convex top surface and a second concave bottom surface; and
wherein when the open end of the main body of the clamp is pushed onto an opposite side of the pole body from the two tracked portions, the first convex top surface of the first protrusion of the first attachment ear and/or the second convex top surface of the second protrusion of the second attachment ear is/are configured for spreading the open end for allowing the pole body to be inserted into the main body of the clamp through the open end of the main body.

7. The clamp of claim 6, wherein when the pole body is positioned in the main body of the clamp:
the first concave bottom surface of the first protrusion of the first attachment ear is configured for locking onto the first bottom portion of the first of the two tracked portions of the tracked tubing tent frame pole; and
the second concave bottom surface of the second protrusion of the second attachment ear is configured for concurrently locking onto the second bottom portion of the second of the two tracked portions of the tracked tubing tent frame pole.

8. The clamp of claim 1 further including at least one thumbnail tab on an exterior of the main body, the at least one thumbnail tab is configured for opening the clamp thereby removing each of the at least one attachment ears from the tracked portions of the tracked tubing tent frame pole for removing the clamp from the tracked tubing tent frame pole.

9. The clamp of claim 8 including two thumbnail tabs:
a first thumbnail tab on a first exterior side of the main body;
a second thumbnail tab on a second exterior side of the main body; and
wherein, the clamp is configured to be removed from the tracked tubing tent frame pole via pulling apart the two thumbnail tabs.

10. The clamp of claim 1 being configured for securing accessories to the tracked tubing tent frame pole; and
wherein the main body of the clamp including an accessories connector configured for securing the accessories to the tracked tubing tent frame pole, wherein the accessories connector including at least one accessories hole through the main body, at least one accessories slot through the main body, at least one accessories passage through the main body, at least one accessories hook on the main body, and combinations thereof.

11. The clamp of claim 10, wherein the accessories connector including:
a thumbnail accessories passage through at least one thumbnail tab on an exterior of the main body;
a bottom accessories slot formed on the exterior of the main body between the main body and a flat portion connected to the main body;
accessory holes on the flat portion;
a bottom accessories passage through at least one rounded addition on an exterior of the main body;
and combinations thereof; and
wherein the accessories securable to the tracked tubing tent frame pole via the clamp including lighting accessories, extension cords, wiring, fire safety signs, and combinations thereof.

12. The clamp of claim 1, wherein the main body is configured to fit around the tracked tubing tent frame pole with a standard tubular cross-section.

13. The clamp of claim 12, wherein the clamp including an essentially rounded inner portion of the main body configured to fit around the standard tubular cross-section.

14. The clamp of claim 13 further comprising:
the attachment portion including two attachment ears including:
a first attachment ear on a first side of the attachment portion, the first attachment ear including:
a first protrusion protruding inward from the first side of the attachment portion;
the first protrusion including a first convex top surface and a first concave bottom surface;
a second attachment ear on a second side of the attachment portion, the second attachment ear including:
a second protrusion protruding inward from the second side of the attachment portion;
the second protrusion including a second convex top surface and a second concave bottom surface;
wherein, the first attachment ear is sized and configured to be inserted into one of the two tracked portions of the tracked tubing tent frame pole and the second attachment ear is sized and configured to be inserted into the other of the two tracked portions of the tracked tubing tent frame pole for securing the clamp on the tracked tubing tent frame pole;
wherein when the open end of the main body of the clamp is pushed onto an opposite side of the pole body from the two tracked portions:
the first convex top surface of the first protrusion of the first attachment ear and/or the second convex top surface of the second protrusion of the second attachment ear is/are configured for spreading the open end for allowing the pole body to be inserted into the main body of the clamp through the open end of the main body;
wherein when the pole body is positioned in the main body of the clamp:
the first concave bottom surface of the first protrusion of the first attachment ear is configured for locking onto a first bottom portion of the first of the two tracked portions of the tracked tubing tent frame pole; and
the second concave bottom surface of the second protrusion of the second attachment ear is configured for locking onto a second bottom portion of the second of the two tracked portions of the tracked tubing tent frame pole;
two thumbnail tabs:
a first thumbnail tab on a first exterior side of the main body;
a second thumbnail tab on a second exterior side of the main body;
wherein, the clamp is configured to be removed from the tracked tubing tent frame pole via pulling apart the two thumbnail tabs;
the main body of the clamp including an accessories connector configured for securing the accessories to the tracked tubing tent frame pole, wherein the accessories connector including:
a thumbnail accessories passage through each of the two thumbnail tabs on the exterior of the main body;
an accessories slot formed on the exterior of the main body between the main body and a flat portion connected to the main body; and
accessory holes on the flat portion.

15. The clamp of claim 1, wherein the main body is configured to fit around the tracked tubing tent frame pole with a rectangular reinforced tubular cross-section.

16. The clamp of claim 15, wherein the clamp including an extended inner portion of the main body configured to fit around the rectangular reinforced tubular cross-section, the extended inner portion including a top rounded inner portion and an elongated straight portion, the clamp further including:
the attachment portion including two attachment ears including:
a first attachment ear on a first side of the attachment portion, the first attachment ear including:
a first protrusion protruding inward from the first side of the attachment portion;
the first protrusion including a first convex top surface and a first concave bottom surface;
a second attachment ear on a second side of the attachment portion, the second attachment ear including:
a second protrusion protruding inward from the second side of the attachment portion;
the second protrusion including a second convex top surface and a second concave bottom surface;
wherein, the first attachment ear is sized and configured to be inserted into one of the two tracked portions of the tracked tubing tent frame pole and the second attachment ear is sized and configured to be inserted into the other of the two tracked portions of the tracked tubing tent frame pole for securing the clamp on the tracked tubing tent frame pole;
wherein when the open end of the main body of the clamp is pushed onto an opposite side of the pole body from the two tracked portions:
the first convex top surface of the first protrusion of the first attachment ear and/or the second convex top surface of the second protrusion of the second attachment ear is/are configured for spreading the open end for allowing the pole body to be inserted into the main body of the clamp through the open end of the main body;
wherein when the pole body is positioned in the main body of the clamp:
the first concave bottom surface of the first protrusion of the first attachment ear is configured for locking onto a first bottom portion of the first of the two tracked portions of the tracked tubing tent frame pole; and
the second concave bottom surface of the second protrusion of the second attachment ear is configured for locking onto a second bottom portion of the second of the two tracked portions of the tracked tubing tent frame pole;
two thumbnail tabs:
a first thumbnail tab on a first exterior side of the main body;
a second thumbnail tab on a second exterior side of the main body;
wherein, the clamp is configured to be removed from the tracked tubing tent frame pole via pulling apart the two thumbnail tabs;
the main body of the clamp including an accessories connector configured for securing the accessories to the tracked tubing tent frame pole, wherein the accessories connector including:
a thumbnail accessories passage through each of the two thumbnail tabs on the exterior of the main body;
bottom accessories passage on each side of the main body through rounded additions on each side of an exterior of the main body; and
accessory holes on a flat bottom portion of the main body.

17. The clamp of claim 15, wherein the clamp including an elongated purely rectangular portion of the main body configured to fit around the rectangular reinforced tubular cross-section.

18. The clamp of claim 17 further including a rounded protrusion on the bottom of the elongated purely rectangular portion of the main body, the rounded protrusion is configured to be positioned in a bottom slot of the rectangular reinforced tubular cross-section.

19. A clamp configured to attach to a tracked tubing tent frame pole for kedered-style tents, the tracked tubing tent frame pole including a pole body with a standard tubular cross-section and two tracked portions on a side of the pole body, the clamp comprising:
a main body with an open end, the main body is sized and configured to fit around the pole body of the tracked tubing tent frame pole with an essentially rounded inner portion;
an attachment portion on the open end of the main body;
at least one attachment ear included with the attachment portion, each of the at least one attachment ear is positioned on one side of the attachment portion;
each of the at least one attachment ear is sized and configured to be inserted into one of the tracked portions of the tracked tubing tent frame pole for securing the clamp on the tracked tubing tent frame pole with the main body of the clamp around the pole body of the tracked tubing tent frame pole; and
wherein the main body is configured to fit around the tracked tubing tent frame pole with the standard tubular cross-section.

20. A clamp configured to attach to a tracked tubing tent frame pole for kedered-style tents, the tracked tubing tent frame pole including a pole body with a rectangular reinforced tubular cross-section and two tracked portions on a side of the pole body, the clamp comprising:
a main body with an open end, the main body is sized and configured to fit around the pole body of the tracked tubing tent frame pole;
an attachment portion on the open end of the main body;
at least one attachment ear included with the attachment portion, each of the at least one attachment ear is positioned on one side of the attachment portion;
each of the at least one attachment ear is sized and configured to be inserted into one of the tracked portions of the tracked tubing tent frame pole for securing the clamp on the tracked tubing tent frame pole with the main body of the clamp around the pole body of the tracked tubing tent frame pole; and
wherein the main body is configured to fit around the tracked tubing tent frame pole with the rectangular reinforced tubular cross-section.
